(19) United States
(12) Patent Application Publication
(10) Pub. No.: US 2009/0283951 A1
(43) Pub. Date: Nov. 19, 2009

(54) CLAMP ASSEMBLY

(76) Inventor: Patrick Rowley, Dallas, TX (US)

Correspondence Address: Ortiz and Lopez, PLLC, P.O. Box 4484, Albuquerque, NM, 87196, US

(21) Appl. No.: 12/436,939

(22) Filed: May 7, 2009

Related U.S. Application Data
(60) Provisional application No. 61/052,827, filed on May 13, 2008.

(51) Int. Cl. B25B 5/00

(52) U.S. Cl. 269/252

(57) ABSTRACT

A clamping jaw includes an unthreaded rod receiver and a swing nut assembly including a swing nut lever and threaded nut coupling integrated thereon. An adjustment knob includes an adjustment knob collar fixed onto a second end of the threaded rob opposite said shaft collar. An idle jaw includes an unthreaded shaft collar adapted to receive and fit over a second end of the threaded rod. The swing nut is operable to interface the threaded nut coupling with the threaded rod held within the unthreaded rod receiver of the clamping jaw and move along the threaded rod by rotation of the adjustment knob while the idle jaw mounted on said threaded rod between the clamping jaw and the adjustment knob remain stationary next to the adjustment knob. The clamping jaw is freely movable along the threaded rod by disengagement of the swing nut and then by rotation of the adjustment knob when the swing nut is engaged with the threaded rod.

### INVENTION PRIORITY

This patent application is a continuation of U.S. Provisional Patent Application Ser. No. 61/052,827, entitled “Clamp Assembly” filed May 13, 2008, by Patrick Rowley, and claims priority thereto. Application 61/052,827 is herein incorporated by reference.

### TECHNICAL FIELD OF THE INVENTION

The present invention is generally related to clamps commonly used during woodworking and cabinetry construction. More particularly, the present invention is related to an improved clamp assembly utilizing a swing release mechanism to facilitate adjustment /removal of a clamp assembly onto/from a workpiece.

### BACKGROUND

Any project with parts that must be glued together requires clamping to insure that the parts are bonded firmly in exactly the right position. Pipe clamps are commonly used where clamping is required. A pipe clamp is a clamp with a long grip which generally uses an ordinary steel pipe to achieve its length. By using a longer pipe, the clamp can be made arbitrarily large. Pipe clamps (also known to be provided in the form of “beam clamps”, or “bar clamps”) consist of a linear pipe, in the form of a beam, rod or bar, with, a pair of opposing jaws. At least one of the opposing jaws is capable of selective movement, after release of a locking mechanism, along the pipe toward or away from the other of the opposing jaws. Finer pressure adjustment against a workpiece held between the opposing jaws is generally provided by a linear screw adjustment located on the opposing jaw. An illustration of a prior art pipe clamp is shown in FIG. 1, labeled as “prior art”, with more information provided in the specification of U.S. Pat. No. 6,039,313 issued to Baculy in March 2000).

As shown in FIG. 1, labeled as “prior art”, a pipe clamp assembly 10 typically includes a linear pipe beam 12, and first and second jaws 14 and 16 respectively, which are slidably supported on linear pipe beam 12. Jaw 14 includes a locking mechanism, generally indicated at 18, for holding jaw 14 at a selected position on linear pipe beam 12. A linear actuator including a hand crank, generally indicated at 20, is provided on jaw 16 for linearly advancing jaw 16 toward and away from jaw 14 to apply and relieve pressure on an article or workpiece interposed between the jaws. The pipe claim in FIG. 1 shows a pair of adaptor blocks 22 releasably secured to each of the jaws 14 and 16. More specifically, the adaptors each include a workpiece interface or gripping surface 38 and are provided with fastener clips 24 which are attached with screws to the side of adaptor block bodies, and which together with the rear wall 28 of adaptor blocks 26 engage and grip a vertical flange portion 30 of jaws 14 and 16, the vertical flange portion 30 defining opposing gripping surfaces for engaging a workpiece there between. As can be understood from the prior art, pipe clamps are very versatile with a length that is determined by the length of the pipe used.

Use of a piece of scrap wood acts as a buffer between the jaws and the material to prevent damage. Furthermore, clamping pressure should be at exact right angles to the glue line otherwise slippage may result. During use, the clamp is initially positioned such that the gripping surface touches the surfaces of workpiece. The jaws are then screwed shut until the clamp feels tight against the workpiece. When glue is used on interfacing pieces of the workpiece, some glue will be squeezed out around the joint, a sign that the clamp is tight enough. Workpiece surfaces can become damaged where clamps are over tightened. The general purpose of a clamp is only to maintain uniform pressure between the two surfaces, not to force them together.

Although pipe clamps currently available in the art of woodworking and cabinetry manufacturing are effective, there is still a need for improvement. Where mass production is involved, there is a need for clamps that can easily be operated and more quickly be adjusted and installed on a workpiece. Furthermore, given the expense of steel, it is more desirable to provide a clamp with less moving parts and less of a requirement for steel. Therefore, the present inventor believes his invention fulfills the need for a workpiece clamp that is easier to use and less expensive to manufacture as will be further described herein.

### SUMMARY OF THE INVENTION

An adjustable clamp including a shaft collar fixed onto a first end of a threaded rod, an adjustment knob including an adjustment knob collar fixed onto a second end of the threaded rob opposite said shaft collar, a clamping jaw including a threaded rod receiver and a swing nut assembly including a swing nut lever and threaded nut coupling integrated thereon, the swing nut operable to interface said threaded nut coupling with the threaded rod held within the threaded rod receiver by rotation of the swing nut lever, and a idle jaw mounted on said threaded rod between the clamping jaw and the adjustment knob, wherein the clamping jaw is movable along the threaded rod when the threaded rod by disengagement of the swing nut and then by rotation of the adjustment knob when the swing nut is engaged with the threaded rod.

### BRIEF DESCRIPTION OF THE DRAWINGS

FIG. 1 is a perspective view of a prior art clamp assembly;

FIG. 2 illustrates a perspective view of a clamp assembly having a clamping jaw and idle jaw in accordance with the invention and also including a cross section of a swing nut assembly installed on the clamping jaw in accordance with features of the preferred embodiment;

FIG. 3 illustrates a first end view of the clamping jaw including , cross sectional details of a swing nut assembly disengaged from contact with a threaded pipe in accordance with features of the present invention;

FIG. 4 illustrates a rear cross sectional view of swing nut assembly installed on the front of a clamping, in accordance with features of the present invention;

FIG. 5 illustrates a side perspective view of the swing nut assembly, in accordance with features of the present invention;

FIG. 6 illustrates a front cross sectional view of a clamping jaw taken from the viewpoint indicated by arrows A-A in FIG. 5 and without installation of the swing nut assembly, in accordance with features of the present invention;

FIG. 7 illustrates a rear perspective view of a clamping jaw without installation of the swing nut assembly, in accordance with features of the present invention;

FIG. 8 illustrates a side cross sectional view of the clamping jaw without installation of the swing nut assembly and indicating the location of a slotted spring pin receiver hole thereon, in accordance with features of the present invention;

FIG. 9 illustrates a front perspective view of an idle jaw, in accordance with features of the present invention;

FIG. 10 illustrates a rear perspective view of an idle jaw in-accordance with features of the present invention;

FIG. 11 illustrates a side cross-sectional view of an idle jaw in accordance with features of the present invention;

FIG. 12 illustrates a front perspective view of an idle jaw in accordance with features of the present invention;

FIG. 13 illustrates a front perspective view of an adjustment knob in accordance with features of the present invention;

FIG. 14a illustrates a side perspective view of an adjustment knob in accordance with features of the present invention;

FIG. 14b illustrates a top view of a torsion spring in accordance with features of the present invention;

FIG. 15 illustrates a side view of a torsion spring in accordance with features of the present invention;

FIG. 16 illustrates a side perspective view of a soft jaw assembly in accordance with features of the present invention; and

FIG. 17 illustrates a side view of a support clip assembly in accordance with features of the present invention.

### DETAILED DESCRIPTION OF PREFERRED EMBODIMENTS

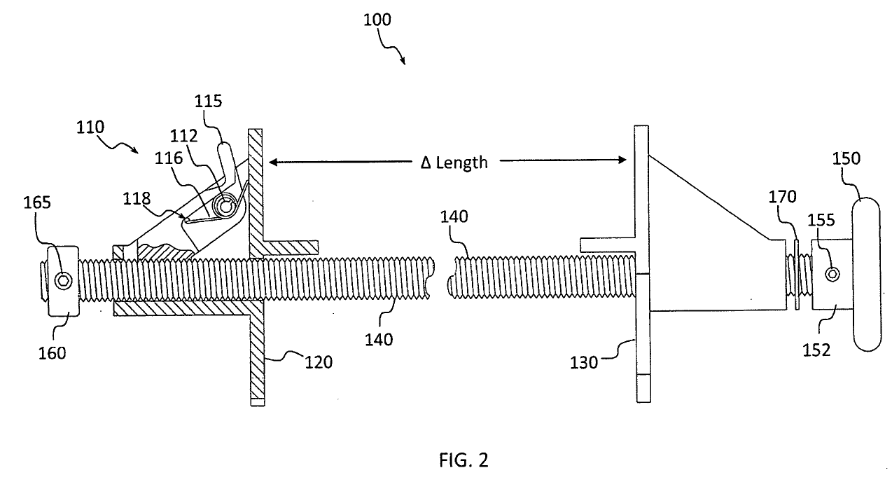

Referring to FIG. 2, a side plan view of a clamp assembly 100 in accordance with features of the preferred embodiment is illustrated. A swing nut assembly 110 is shown mounted on a clamping jaw 120 and in threaded contact with a threaded rod 140 received into the clamping jaw 120. An idle jaw 130 is also shown with the threaded rod 140 received therein. A shaft collar 160 prevents the clamping jaw and idle jaw from slipping of a first end of the threaded rod. The shaft collar 160 is fixably mounted onto the threaded rod 140 by a shaft collar locking screw 165. An adjustment knob 150 is also fixably mounted to the threaded rod 140 opposite the shaft collar 160. The adjustment knob is fixably mounted to the threaded rod 140 by an adjustment knob collar and adjustment knob collar screw 155. A thrust bearing 170 can be disposed between the adjustment knob 150 and idle clamp 130 to buffer contact there between.

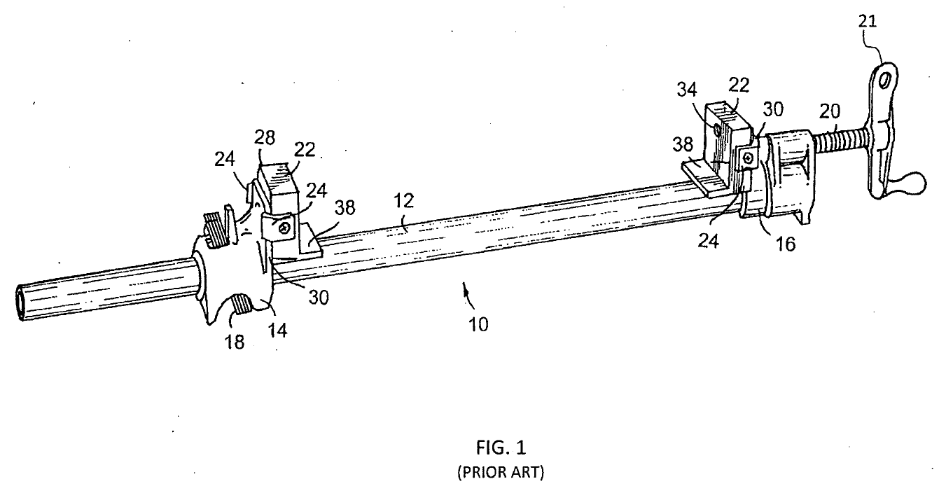

During use, the clamp assembly 100 is used to firmly hold together a workpiece of variable length between the clamping jaw 120 and idle jaw 130. Tension from a tension torsion spring 116 keeps the swing nut in contact with the threaded rod 140 unless the swing nut lever 115 is moved (rotated) by a user. The user moves the swing nut assembly 110 out of contact with the threaded rod 140 for preliminary adjustment of the clamp jaw 120 and idle jaw 130 onto a workpiece. Then, the swing nut assembly 110 is allowed to engage the threaded rod 140 when the user released the swing nut lever 115, and then the user can rotate the adjustment knob 150 (e.g., clockwise rotation) to thereby apply more pressure onto the workpiece by moving the clamping jaw 120 towards the idle jaw 130. Pressure can be released when the using rotates the adjustment knob in an opposite direction (e.g., counterclockwise rotation). It should be appreciated that a hand crank 21 such as that shown in FIG. 1 can be used with the present invention to ease user manipulation of the clamping jaw 120 against a workpiece.

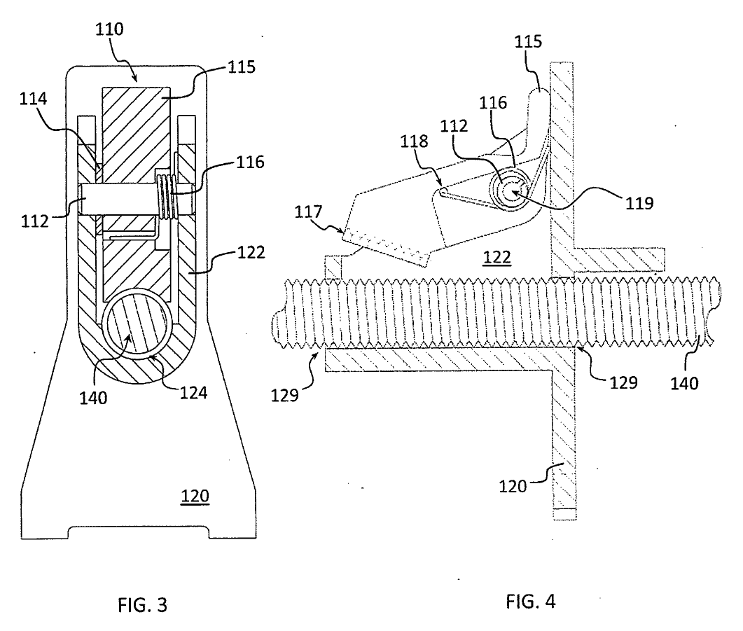

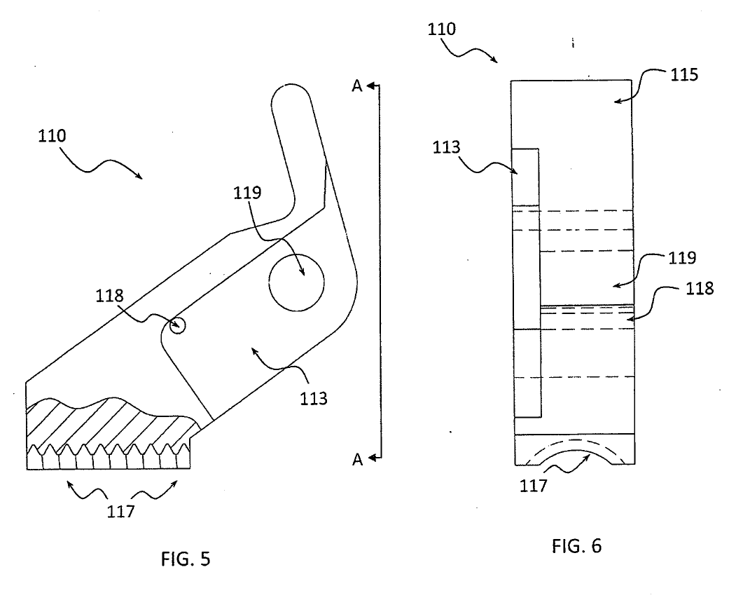

Referring to FIGS. 1-5, the swing nut assembly 110 is mounted onto the idle jaw 130 within a clamping jaw support frame 122 having a slotted spring pin receiver hole 128 formed therein. The swing nut assembly also has a slotted spring pin receiver 119 formed therein. A slotted spring pin enables the swing nut assembly to be rotatably mounted to the clamping jaw support frame and be moved into and out of threaded contact with a threaded rod 140. The swing nut assembly 110 includes a threaded nut coupling 117 and a swing nut lever 115. The swing nut lever 115 enables a user to move the swing nut assembly 110, and in particular the threaded nut coupling 117, out of contact with a threaded rod 140. Tension is maintained between the threaded nut coupling 117 and a threaded rod 140 by a torsion spring 116. The torsion spring is wrapped around the slotted spring pin and rest-against a torsion spring receiver holder 113 area formed in the swing nut assembly 110. One end of the torsion spring 116 rest against the clamping jaw 130 while a second end is held within a torsion spring receiver 118 formed within the swing nut assembly 110. The tension torsion spring's 116 only purpose is to keep the threaded nut coupling 117 portion of the swing nut in contact with the threaded rod 140 unless the swing nut lever 115 is moved (rotated) by a user.

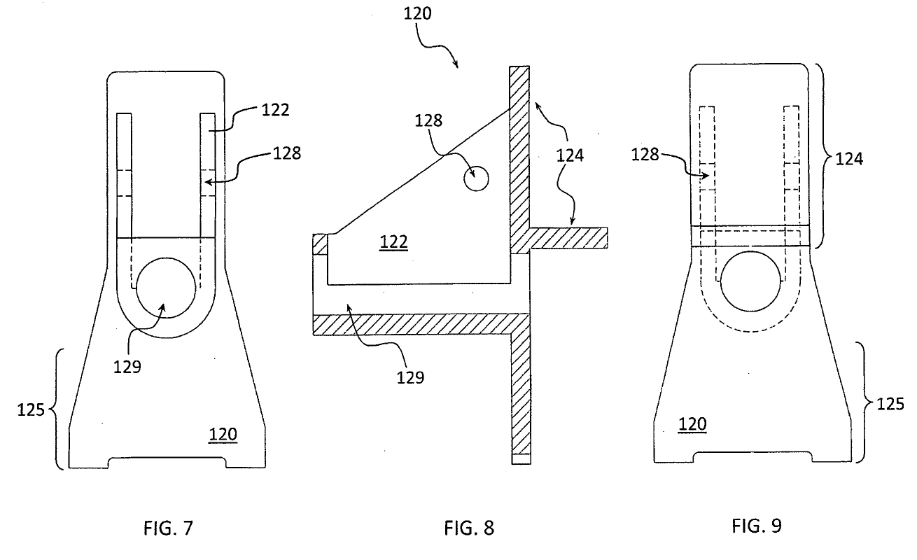

Referring to FIGS. 6-8, details of the clamping jaw 120 are illustrated. The clamping jaw 120 includes a base portion 125 and a workpiece interface portion 124, the workpiece interface portion 124 provided in the shape of an L-shaped contact surface. A threaded rod 140 is received in the clamping jaw 120 through a threaded rod receiver 129 formed therein. A clamping jaw support frame 122 provides strength to and force distribution from the workpiece interface portion 124 when in use. A slotted spring pin receiver hole 118 is formed in walls of the clamping jaw support frame 122 to receive and hold a slotted spring pin used to rotatably mount a swing nut assembly on the clamping jaw 120.

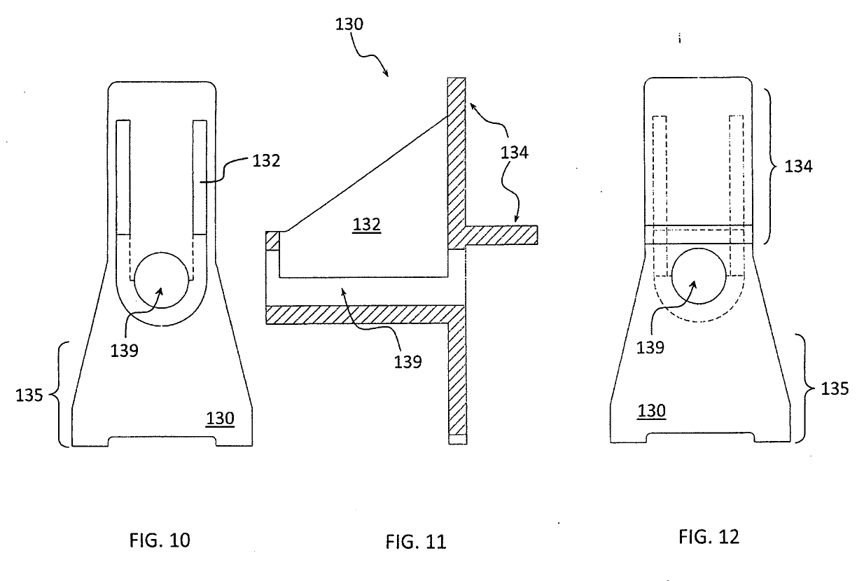

Referring to FIGS. 9-11, details of the idle jaw 130 are illustrated. The idle jaw 130 includes a base portion 135 and a workpiece interface portion 134, the workpiece interface portion 134 provided in the shape of an L-shaped contact surface. A threaded rod 140 is received in the clamping jaw 120 through a threaded rod receiver 139 formed therein. An idle jaw support frame 132 provides strength to and force distribution from the workpiece interface portion 134 when in use.

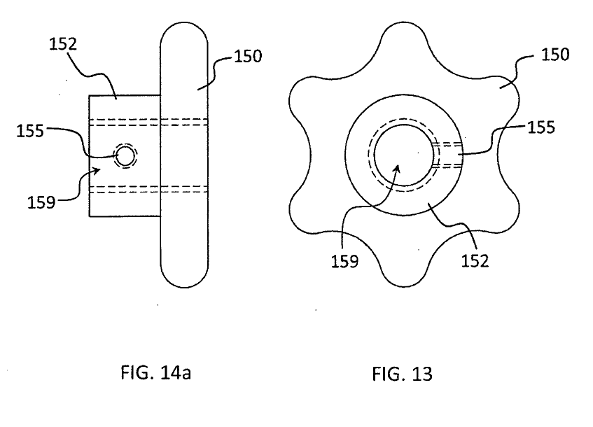

Referring to FIGS. 12-13, front and side perspectives of an adjustment knob 150 including an adjustment knob collar 152 immovably fixable onto said threaded rob by a adjustment knob collar screw 155 on a second end of said threaded rod 140 is illustrated. The adjustment knob 150 can be fixed on one end of a threaded rob 140 to enable a user to easily rotate the adjustment knob, and also thereby the threaded rod 140, clockwise and counterclockwise, which causes the clamping jaw 120 and idle jaw 130 to move towards or away from each other during use of the clamp assembly 100.

It should be appreciated that the adjustment knob 150 can also be provided in the form of a hand crank 121 similar to that that shown in FIG. 1, if it will facilitate ease of use over the clamp system 100. Hand cranks with a handle like that shown in FIG. 1 are well known in the art.

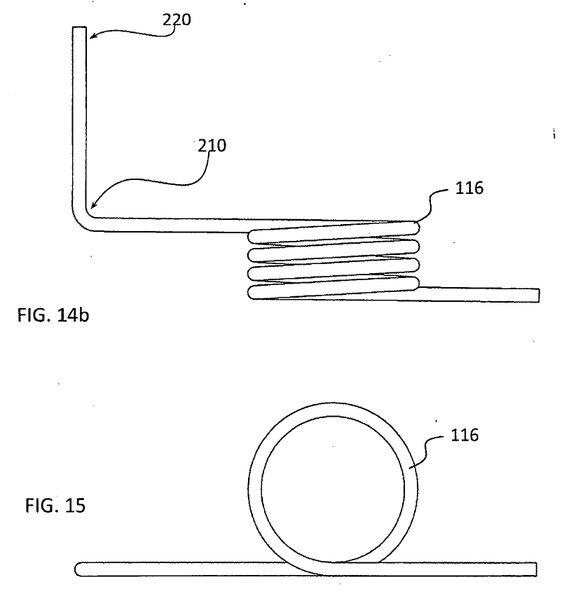

Referring to FIGS. 14b-15, top and side perspectives of a torsion spring 116 are illustrated. The torsion spring 116 used in the present invention can include a ninety degree spring elbow 210 at one end forming a spring receiver insertion point 220 that is inserted into and received by a torsion spring receiver 118 formed on the swing nut assembly 110.

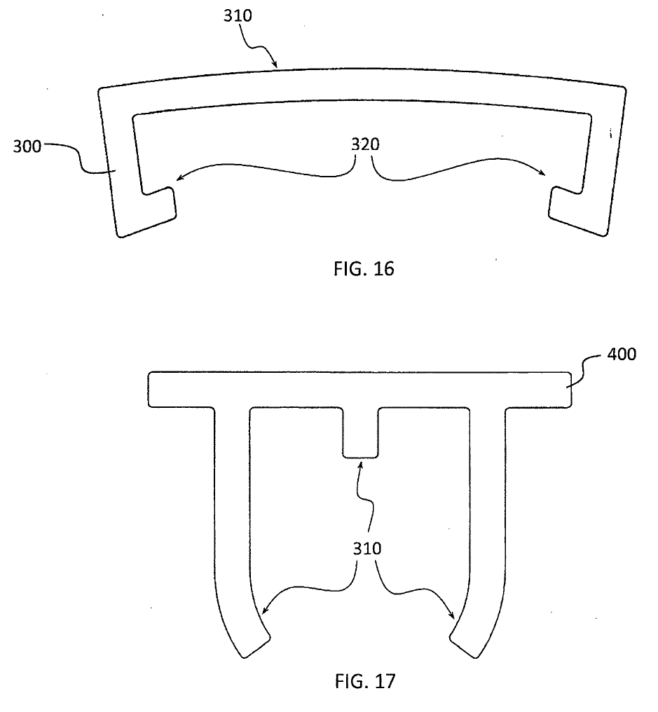

Referring to FIG. 16, a soft jaw adapter 300 is illustrated. The soft jaw adapter 300 can be placed over surface of the workpiece interface portions 124/134 of the clamping jaw 120 and idle jaw 130 in order to ease the negative effect of force and contact between the workpiece surface (not shown) and the clamp hardware. The soft jaw adapted 300 operate as an interface between the workpiece interface portions 124/134 and the workpiece given curved surface area 310. Ideally, the soft jaw adapter 300 is made of softer material (e.g., plastic, rubber or aluminum) than the metal used for the clamp assembly 100.

Referring to FIG. 17, a support clip assembly 400 is illustrated. The support clip assembly can be placed onto exposed portions of the threaded rod 140 between the clamping jaw 120 and idle jaw 130 in order to minimize contact between the workpiece and the threaded rod 140. The support clip assembly 400 fits over a threaded rod 140 and is held by contact with the threaded rod 140 at contact points 410 shown within the support clip assembly 400.

1. A clamp assembly, comprising an adjustable clamp including a shaft collar fixed onto a first end of a threaded rod, an adjustment knob including an adjustment knob collar fixed onto a second end of the threaded rod opposite said shaft collar, a clamping jaw including an unthreaded rod receiver.

2. The clamp assembly of claim 1, further comprising a swing nut assembly including a swing nut lever and threaded nut coupling integrated thereon, the swing nut operable to interface said threaded nut coupling with the threaded rod held within the threaded rod receiver by rotation of the swing nut lever,

3. The clamp assembly of claim 1, further comprising an idle jaw mounted on said threaded rod between the clamping jaw and the adjustment knob.

4. The clamp assembly of claim 1, wherein the clamping jaw is movable along the threaded rod after disengagement of the swing nut and is movable along the threaded rod by rotation of the adjustment knob on said threaded rod when the swing nut is engaged with the threaded rod and the clamping jaw and remains fixed on said threaded rod when the adjustment knob is not rotated.

5. The clamp assembly of claim 2, wherein the clamping jaw is movable along the threaded rod after disengagement of the swing nut and is movable along the threaded rod by rotation of the adjustment knob on said threaded rod when the swing nut is engaged with the threaded rod and the clamping jaw and remains fixed on said threaded rod when the adjustment knob is not rotated.

6. The clamp assembly of claim 3, wherein the clamping jaw is movable along the threaded rod after disengagement of the swing nut and is movable along the threaded rod by rotation of the adjustment knob on said threaded rod when the swing nut is engaged with the threaded rod and the clamping jaw and remains fixed on said threaded rod when the adjustment knob is not rotated.

7. The clamp assembly of claim 2, further comprising an idle jaw mounted on said threaded rod between the clamping jaw and the adjustment knob.

8. The clamp assembly of claim 7, wherein the clamping jaw is movable along the threaded rod after-disengagement of the swing nut and is movable along the threaded rod by rotation of the adjustment knob on said threaded rod when the swing nut is engaged with the threaded rod and the clamping jaw and remains fixed on said threaded rod when the adjustment knob is not rotated.

9. The clamp assembly of claim 3, further comprising a swing nut assembly including a swing nut lever and threaded nut coupling integrated thereon, the swing nut operable to interface said threaded nut coupling with the threaded rod held within the threaded rod receiver by rotation of the swing nut lever,

10. The clamp assembly of claim 9, wherein the clamping jaw is movable along the threaded rod after disengagement of the swing nut and is movable along the threaded rod by rotation of the adjustment knob on said threaded rod when the swing nut is engaged with the threaded rod and the clamping jaw and remains fixed on said threaded rod when the adjustment knob is not rotated.

11. A clamp assembly, comprising an adjustable clamp including a shaft collar fixed onto a first end of a threaded rod, an adjustment knob including an adjustment knob collar fixed onto a second end of the threaded rob opposite said shaft collar, a clamping jaw including an unthreaded rod receiver and a swing nut assembly including a swing nut lever and threaded nut coupling integrated thereon, the swing nut operable to interface said threaded nut coupling with the threaded rod held within the threaded rod receiver by rotation of the swing nut lever, and a idle jaw mounted on said threaded rod between the clamping jaw and the adjustment knob.

12. The clamp assembly of claim 11, wherein the clamping jaw is movable along the threaded rod after disengagement of the swing nut and is movable along the threaded rod by rotation of the adjustment knob on said threaded rod when the swing nut is engaged with the threaded rod and the clamping jaw and remains fixed on said threaded rod when the adjustment knob is not rotated.

13. An adjustable clamp, comprising
a threaded rod;
a shaft collar immovably fixable onto said threaded rod by a shaft collar screw at a first end of said threaded rod;
a idle jaw including a threaded rod receiver and a swing nut assembly including a swing nut lever and threaded nut coupling integrated thereon, said swing nut operable to interface said threaded nut coupling with said threaded rod held within said threaded rod receiver by rotation of said swing nut lever thereby causing said idle jaw to remain fixed on said threaded rod;
an adjustment knob including an adjustment knob collar immovably fixable onto said threaded rob by a adjustment knob collar screw on a second end of said threaded rod opposite said shaft collar; and
a clamping jaw mounted by an unthreaded over said threaded rod between said idle jaw and said an adjustment knob;
wherein said idle jaw and swing nut assembly are adjustably movable along said threaded rod when said threaded rod is rotated, wherein rotation of said threaded rod is facilitated by rotational operation of said adjustment knob along said threaded nut coupling.
